(19) United States
(12) Patent Application Publication
(10) Pub. No.: US 2017/0305141 A1
(43) Pub. Date: Oct. 26, 2017

(54) APPARATUS AND METHOD FOR FABRICATING THREE-DIMENSIONAL OBJECTS

(71) Applicant: Shozo SAKURA, Kanagawa (JP)

(72) Inventor: Shozo SAKURA, Kanagawa (JP)

(73) Assignee: RICOH COMPANY, LTD., Tokyo (JP)

(21) Appl. No.: 15/468,854

(22) Filed: Mar. 24, 2017

(30) Foreign Application Priority Data
Apr. 26, 2016 (JP) 2016-088051
Feb. 6, 2017 (JP) 2017-019622

(51) Int. Cl. B33Y 70/00; B33Y 30/00; B33Y 40/00; B33Y 10/00

(52) U.S. Cl. CPC B33Y 70/00; B33Y 10/00; B33Y 30/00; B33Y 40/00

(57) ABSTRACT

An apparatus includes a small-diameter-particle powder supplier to supply a small-diameter-particle powder to a surface of an object faulted by binding fabrication powder. The small-diameter-particle powder and the fabrication powder are identical in composition. An average particle diameter of the small-diameter-particle powder is smaller than an average particle diameter of the fabrication powder.

### CROSS-REFERENCE TO RELATED APPLICATIONS

This patent application is based on and claims priority pursuant to 35 U.S.C. §119(a) to Japanese Patent Application No. 2017-019622, filed on Feb. 6, 2017 and No. 2016-088051, filed on Apr. 26, 2016, in the Japan Patent Office, the entire disclosure of each of which is hereby incorporated by reference herein.

### BACKGROUND

### Technical Field

Aspects of the present disclosure relate to an apparatus and a method for fabricating three-dimensional objects.

### Related Art

A three-dimensional fabricating apparatus is known that foams a three-dimensional object by repeated laminating of a plurality of layers. More specifically, the object is formed by repeatedly forming a powder layer with fabrication powder and binding particles of the powder together in accordance with fabrication information instructions for each such layer.

### SUMMARY

In at least one embodiment of the present disclosure, there is provided an improved apparatus for fabricating a three-dimensional object. The apparatus includes a small-diameter-particle powder supplier that supplies small-diameter-particle powder to a surface of an object formed by binding fabrication powder. The small-diameter-particle powder and the fabrication powder are identical in composition. An average particle diameter of the small-diameter-particle powder is smaller than an average particle diameter of the fabrication powder.

### BRIEF DESCRIPTION OF THE DRAWINGS

FIG. 1 is a perspective view of a three-dimensional fabricating apparatus according to a first embodiment of the present disclosure;

FIG. 2 is a schematic view of a step in a process of forming a fabrication layer;

FIG. 3 is a schematic view of a step in a process of foaming a thin layer of a fabrication powder on a formed fabrication layer;

FIG. 4 is a flowchart of steps in a fabrication process according to the embodiment of the present disclosure;

FIG. 5 is a schematic view of a surface portion of a three-dimensional object, on which small-diameter-particle powder is deposited;

FIG. 6 is a schematic view of a three-dimensional object fabricated according to three-dimensional shape data;

FIG. 7 is a schematic view of a status when a final laminated object (three-dimensional object) is fabricated in a fabrication chamber;

FIG. 8 is a schematic view of a heating apparatus;

FIG. 9 is a perspective view of a small-diameter-particle powder supply apparatus according to the embodiment of the present disclosure;

FIG. 10 a perspective view of an adhesive spray apparatus;

FIG. 11 is a schematic view of a small-diameter-particle powder supply apparatus according to another embodiment of the present disclosure; and

FIG. 12 is a schematic view of a recovery apparatus according to an embodiment of the present disclosure.

### DETAILED DESCRIPTION

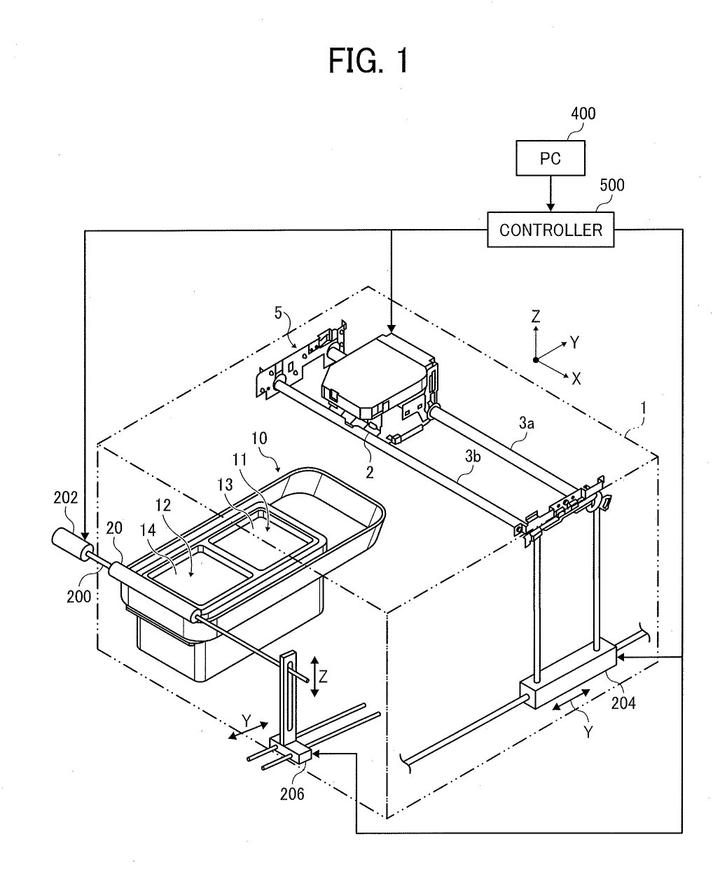

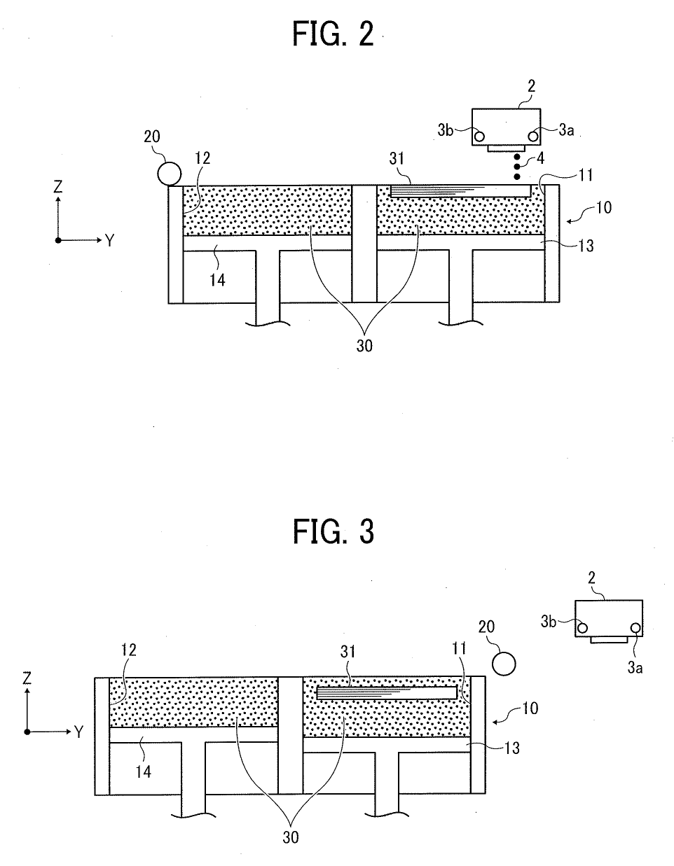

Hereinafter, a three-dimensional fabricating apparatus according to an embodiment of the present disclosure will be described referring to accompanying drawings. FIG. 1 is a perspective view of a three-dimensional fabricating apparatus 1 according to the present embodiment. FIG. 2 is a schematic view illustrating a step in a process of forming a fabrication layer by binding fabrication powder 30 of a portion based on fabrication information using the three-dimensional fabricating apparatus 1 of the present embodiment. FIG. 3 is a schematic view illustrating a step in a process of forming a thin layer of fabrication powder 30 on a foamed fabrication layer.

The three-dimensional fabricating apparatus 1 of the present embodiment includes a head unit 5, a powder chamber 10, and a recoat roller 20.

The head unit 5 includes a liquid discharge head 2. The liquid discharge head 2 discharges fabrication liquid 4. The powder chamber 10 stores fabrication powder 30. The fabrication liquid 4 acts as binding agent, which solidifies the fabrication powder 30 stored in the powder chamber 10. The liquid discharge head 2 is movable along guide rods 3a and 3b extending along a direction indicated by arrow X in FIG. 1.

A known liquid discharge head used for a printing head of an inkjet recording apparatus can be used as the liquid discharge head 2. Virtually any type of liquid discharge head can be used in the present embodiment so long as the liquid discharge head can discharge fabrication liquid 4.

The powder chamber 10 includes a fabrication chamber 11 and a supply chamber 12. The fabrication chamber 11 is used for fabricating a three-dimensional object. The supply chamber 12 stores the fabrication powder 30 supplied to the fabrication chamber 11. The fabrication chamber 11 includes a fabrication stage 13 in the fabrication chamber 11. The fabrication stage 13 is driven to move a bottom face of the fabrication chamber 11 upward and downward in a vertical direction indicated by arrow Z in FIG. 1. The supply chamber 12 includes a supply stage 14 in the supply chamber 12. The supply stage 14 is driven to move a bottom face of the supply chamber 12 upward and downward in the direction indicated by arrow Z.

The recoat roller 20 has a rotation shaft 200 extending in the direction indicated by arrow X in FIG. 1. A motor 202 drives and rotates the recoat roller 20 around the rotation shaft 200.

The head unit 5 and the powder chamber 10 are movable relative to each other by a first drive unit 204 in a direction indicated by arrow Y in FIG. 1. Here, the first drive unit 204 illustrated in FIG. 1 moves the head unit 5 relative to the powder chamber 10 in the direction indicated by arrow Y. However, the first drive unit 204 may move the powder chamber 10 relative to the head unit 5.

Further, the first drive unit 204 may move both of the head unit 5 and the powder chamber 10 relative to each other. Further, the recoat roller 20 and the powder chamber 10 are movable relative to each other by a second drive unit 206 in the directions indicated by arrow Y and Z in FIG. 1. The second drive unit 206 moves the recoat roller 20 in the direction indicated by arrow Y in FIG. 1. However, the second drive unit 206 may move the powder chamber 10 or move both of the recoat roller 20 and the powder chamber 10 in the direction indicated by arrow Y in FIG. 1.

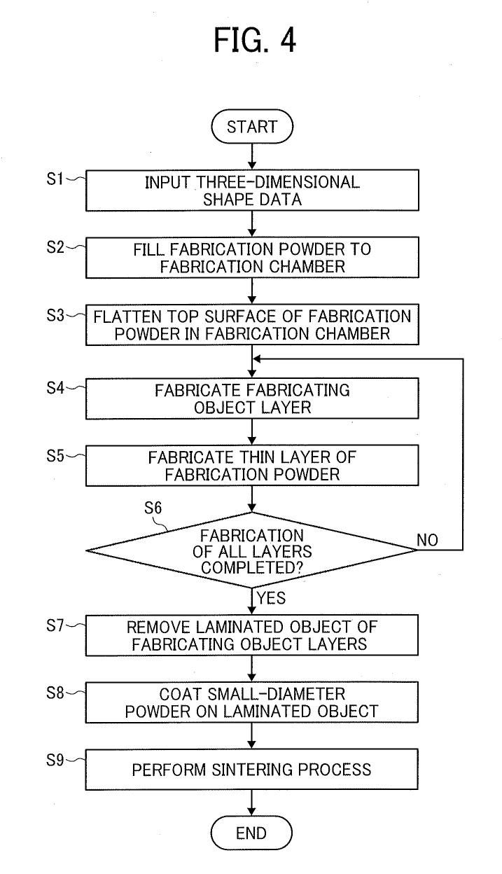

FIG. 4 is a flowchart of steps in a fabrication process (including smoothing process) executed by the three-dimensional fabricating apparatus 1 according to the present embodiment.

Three-dimensional shape data (fabrication information) of the three-dimensional object 32, which is fabricated by the three-dimensional fabricating apparatus 1 of the present embodiment, is input to the three-dimensional fabricating apparatus 1 from an external device such as a personal computer 400. The personal computer 400 is communicatively connected to the three-dimensional fabricating apparatus 1 in a wired or wireless manner (S1) as illustrated in FIG. 1.

A controller 500 of the three-dimensional fabricating apparatus 1 generates data (fabrication slice data) of a large number of object layers 31 decomposed in the vertical direction based on the input three-dimensional shape data input to the apparatus 1 from the external device such as the personal computer 400. The generated slice data corresponds to each of the object layers 31 foamed by solidifying the fabrication powder 30 with the fabrication liquid 4 discharged from the liquid discharge head 2 of the three-dimensional fabricating apparatus 1. The thickness of the object layer 31 is determined by the design of the three-dimensional fabricating apparatus 1.

First, the fabrication chamber 11 is filled with fabrication powder 30 by moving the powder inside the supply chamber 12 to the fabrication chamber 11 with the recoat roller 20 when the fabrication stage 13 in the fabrication chamber 11 is positioned at a predetermined height when fabricating a three-dimensional object (S2). Then, a top face of the fabrication powder 30 in the fabrication chamber 11 is flattened by the recoat roller 20, which is driven and rotated by the motor 202, in the direction indicated by arrow Y relative to the powder chamber 10 (S3).

Then, the controller 500 moves the head unit 5 in the direction indicated by arrow Y relative to the powder chamber 10 to the predetermined position above the fabrication chamber 11. The controller 500 further discharges the fabrication liquid 4 selectively on the portion according to the three-dimensional shape data (slice data) of the three-dimensional object while scanning the liquid discharge head 2 in the head unit 5 in the direction indicated by arrow X.

After completing the discharging process of one line or a plurality of lines by discharging the fabrication liquid 4 while scanning the liquid discharge head 2 in the head unit 5 in the direction indicated by arrow X, the controller 500 moves the head unit 5 relative to the powder chamber 10 in the direction indicated by arrow Y. Then, the controller 500 performs the discharge process of one line or a plurality of lines in the direction indicated by arrow X again.

By repeating the discharging process described above, the controller 500 discharges the fabrication liquid 4 from the liquid discharge head 2 selectively on a portion in an X and Y plane according to the three-dimensional shape data (slice data). As a result, the particles of the fabrication powder 30 of the portion on which the fabrication liquid 4 is discharged are bound and solidified to form one object layer 31.

Next, the controller 500 moves the supply stage 14 upward, moves the fabrication stage downward, and moves the powder chamber 10 and the recoat roller 20 relatively in the direction indicated by arrow Y. The rotating recoat roller 20 thereby transfers the upper layer portion of the fabrication powder 30 to the fabrication chamber 11 from the supply chamber 12. Further, the recoat roller 20 flattens the top face of the fabrication powder 30 transferred to the fabrication chamber 11. As a result, a thin layer of the fabrication powder 30 is formed over the previously formed object layer 31 in the fabrication chamber 11 as illustrated in FIG. 3.

Again, the controller 500 discharges the fabrication liquid 4 selectively on the portion according to the three-dimensional shape data (slice data) with the liquid discharge head 2 while moving the liquid discharge head 2 of the head unit 5 in the direction indicated by arrow X. The controller 500 thereby forms a new object layer 31 over the previously formed object layer 31. The processes described above are repeated, and the controller 500 laminates a plurality of object layers 31 and forms a laminated object including multiple object layers 31. Then, the controller executes a smoothing process to smooth the surface of the laminated object.

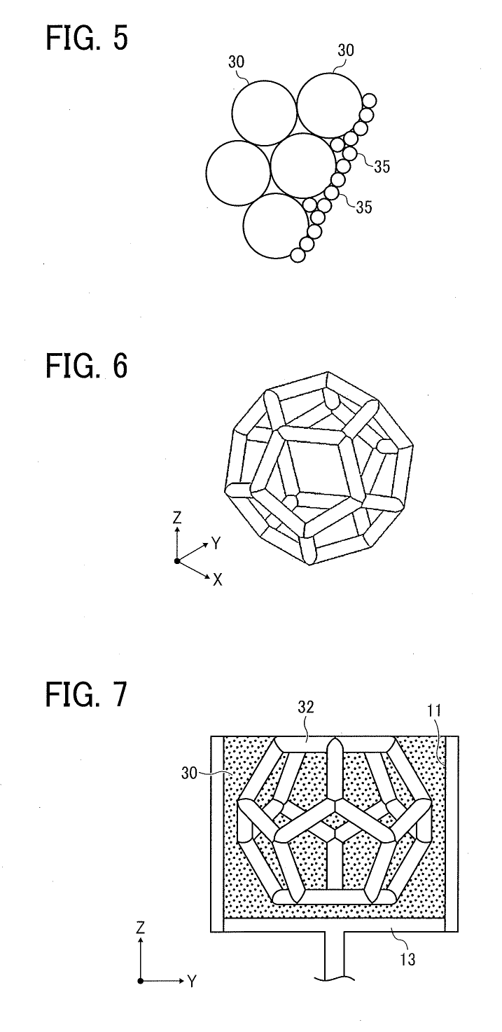

FIG. 5 is a schematic view of a surface portion of a three-dimensional object, on which small-diameter-particle powder is deposited. The smoothing process of the present embodiment is a process of supplying small-diameter-particle powder 35 to the surface of the previously formed laminated object and bind the small-diameter-particle powder 35 to the surface of the laminated object. The average particle diameter of the small-diameter-particle powder 35 is smaller than the average particle diameter of the fabrication powder 30. As illustrated in FIG. 5, the smoothing process smoothing a surface of the laminated object by inserting and filling the small-diameter-particle powder 35 into the asperities in the surface of the laminated object.

In the present embodiment, the smoothing process is performed after completing the fabrication of the final laminated object according to the input three-dimensional shape data (three-dimensional object). However, the smoothing process can be performed during a halfway stage of the fabrication of the laminated object, and the final laminated object is fabricated by laminating the remaining portion of the fabrication layers.

Next, examples of a smoothing process will be described in further detail bellow.

The present embodiment fabricates a final laminated object (three-dimensional object) in the fabrication chamber 11 as illustrated in FIG. 7 by executing the fabrication process according to the three-dimensional shape data corresponding to the three-dimensional object as illustrated in FIG. 6. In this way, after fabricating the three-dimensional object 32 (YES at S6 in FIG. 4), the smoothing process removes any surplus fabrication powder 30, to which the fabrication liquid 4 is not applied, from the three-dimensional object 32 by taking out the three-dimensional object 32 from the fabrication chamber 11 (S7 in FIG. 4).

Next, the three-dimensional object 32 taken out from the fabrication chamber 11 is transferred to a small-diameter-particle powder supply apparatus 600 for coating the small-diameter-particle powder 35 on the three-dimensional object 32 (S8 in FIG. 4). The small-diameter-particle powder supply apparatus 600 coats the small-diameter-particle powder 35 on the surface of the three-dimensional object 32 taken out from the fabrication chamber 11. As a material used for the small-diameter-particle powder 35, material having an average particle diameter smaller than the average particle diameter of the fabrication powder 30 is preferable.

Although any material can be used for the fabrication powder 30 if the material can be bound to the surface of the three-dimensional object 32, the material of the small-diameter-particle powder 35 is preferably the same material as the fabrication powder 30. Thus, the small-diameter-particle powder 35 and the fabrication powder 30 are identical in composition. If the material of the small-diameter-particle powder 35 is the same material as the fabrication powder 30, a binding process of coated small-diameter-particle powder 35 can be performed parallel with and within the sintering process of the fabrication powder 30 that constitutes three-dimensional object 32, thereby simplifying the process of manufacturing the three-dimensional object 32.

Further, using the small-diameter-particle powder 35, the material of which is the same as the fabrication powder 30 can reduce surface unevenness of the laminated object without additional processing of the surface of the laminated object. Thus, the surface unevenness of the material that constitutes the laminated object itself can be reduced.

Thus, the present embodiment uses the small-diameter-particle powder 35 having an average particle diameter smaller than the average particle diameter of the fabrication powder 30, the material of which is same with the material of the fabrication powder 30.

Further, the average particle diameter of the small-diameter-particle powder 35 is preferably equal to or smaller than the average particle diameter of the fabrication powder 30. If the fabrication process is performed using the fabrication powder 30 having the same average particle diameter with the small-diameter-particle powder 35 of the present embodiment, obtaining the three-dimensional object having a smooth surface similar to the present embodiment is possible without performing the smoothing process.

However, usually the average particle diameter of the fabrication powder 30 is preferably about several tens of micrometers. Fabrication powder having an average particle diameter less than 1/10 (about several micrometer) of the normal average particle diameter of the fabrication powder 30 degrades the fluidity of the fabrication powder 30. Thus, it is difficult to obtain high density in the thin layer of the fabrication powder 30 formed by the recoat roller 20, which results in insufficient mechanical strength of the three-dimensional object. Therefore, fabrication of the three-dimensional object itself becomes difficult.

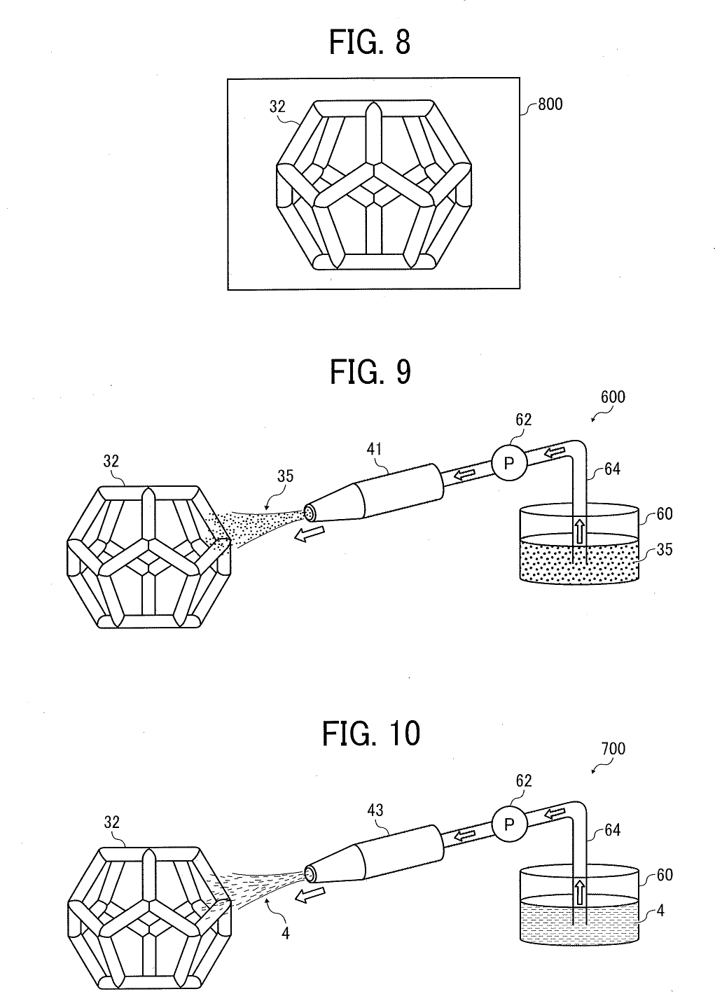

Next, the three-dimensional object 32 coated with the small-diameter-particle powder 35 is transferred to a heating apparatus 800 as illustrated in FIG. 8.

The heating apparatus 800 sinters the un-sintered three-dimensional object 32 coated with the small-diameter-particle powder 35 by heating the un-sintered three-dimensional object 32 (S9 in FIG. 4). By the sintering process, the three-dimensional object 32 is degreased and sintered, and the particles of the fabrication powder 30 are bound and shrunk to become dense inside the three-dimensional object 32. Further, the small-diameter-particle powder 35 is inserted and filled into the concave portion of the unevenness existed on the surface of the three-dimensional object. The small-diameter-particle powder 35 inserted and filled into the concave portion is bound to the fabrication powder 30 on the surface of the three-dimensional object 32. Thus, the unevenness of the surface of the three-dimensional object is reduced, and the surface of the three-dimensional object becomes smooth. Especially, because the sintering process can greatly reduce granular feeling of the small-diameter-particle powder 35, a further smooth surface of the three-dimensional object 32 can be obtained.

FIG. 9 illustrates an example of the small-diameter-particle powder supply apparatus 600 according to the embodiment of the present disclosure.

The small-diameter-particle powder supply apparatus 600 as illustrated in FIG. 9 includes a sprayer to spray the small-diameter-particle powder 35 in a powdery state to the surface of the un-sintered three-dimensional object 32 from a spray nozzle 41. The small-diameter-particle powder supply apparatus 600 includes a tank 60, supply channel 64, and a pump 62. The tank 60 accommodates the small-diameter-particle powder 35. The supply channel 64 and the pump 62 supplies the small-diameter-particle powder 35 to the spray nozzle 41. The pump 62 is provided on the supply channel 64. The pump 62 supplies the small-diameter-particle powder 35 in the tank 60 to the spray nozzle 41 via the supply channel 64.

The small-diameter-particle powder supply apparatus 600 of the present embodiment can supply the powdery small-diameter-particle powder 35 even on the surface portion, which is dead angle from outside the three-dimensional object 32. Because the small-diameter-particle powder 35 can running around the three-dimensional object 32, the small-diameter-particle powder 35 can attach to the dead angle portion of the surface of the three-dimensional object 32.

Therefore, the small-diameter-particle powder supply apparatus 600 of the present embodiment can supply the small-diameter-particle powder 35 the entire surface of the three-dimensional object 32 even the surface of the three-dimensional object 32 has a dead angle. Thus, the small-diameter-particle powder supply apparatus 600 can smooth the entire surface of the three-dimensional object 32.

At this time, the small-diameter-particle powder 35 deposited on the surface of the three-dimensional object 32 may be fallen from the surface of the three-dimensional object 32 before the sintering process. In this case, a pretreatment may be performed before spraying the small-diameter-particle powder 35 on the surface of the three-dimensional object 32 by the spray nozzle 41. The pretreatment supplies an adhesive to the surface of the three-dimensional object 32. For example, the fabrication liquid 4 discharged from the liquid discharge head 2 can be used as an adhesive.

Specifically, as illustrated in FIGS. 9 and 10, first, a spray nozzle 43 of an adhesive spray apparatus 700 sprays the fabrication liquid 4 on the surface of the three-dimensional object 32. Second, the spray nozzle 41 of the small-diameter-particle powder supply apparatus 600 sprays the small-diameter-particle powder 35 on the surface of the three-dimensional object 32.

As illustrated in FIG. 10, the adhesive spray apparatus 700 has a similar configuration with the small-diameter-particle powder supply apparatus 600 as illustrated in FIG. 9. The adhesive spray apparatus acts as a small-diameter-particle powder binder and an adhesive applier. The adhesive spray apparatus 700 includes a tank 60, supply channel 64, and a pump 62. The tank 60 accommodates the fabrication liquid 4. The supply channel 64 and the pump 62 supplies the fabrication liquid 4 to the spray nozzle 43. The pump 62 is provided on the supply channel 64. The pump 62 supplies the fabrication liquid 4 in the tank 60 to the spray nozzle 43 via the supply channel 64.

According to the present configuration, the small-diameter-particle powder 35 deposited on the surface of the three-dimensional object 32 is fixed to the surface of the three-dimensional object 32. Thus, the present embodiment can prevent the small-diameter-particle powder 35 fallen from the surface of the three-dimensional object 32. Further, by falling surplus small-diameter-particle powder 35 form the surface of the three-dimensional object 32, a layer thickness of the small-diameter-particle powder 35 deposited on the surface of the three-dimensional object 32 can be made uniform.

Thereby, unevenness of the dimensional accuracy can be restrained. The unevenness is occurred by the smoothing process of the three-dimensional object 32, which is a process of attaching the small-diameter-particle powder 35 on the surface of the three-dimensional object 32.

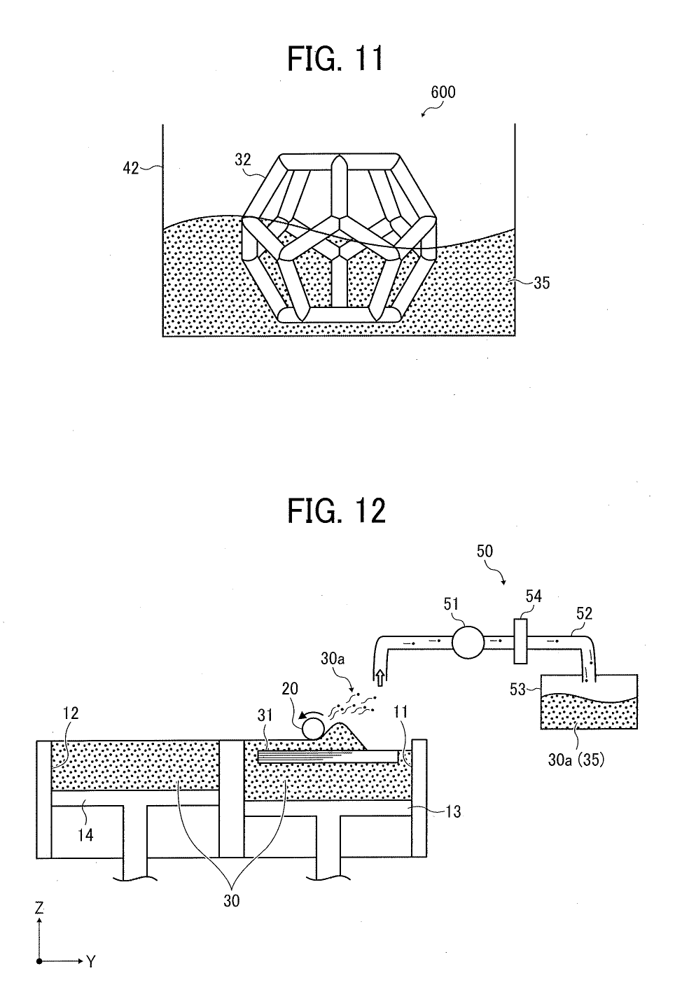

FIG. 11 illustrates an example of the small-diameter-particle powder supply apparatus 600 according to another embodiment of the present disclosure.

The small-diameter-particle powder supply apparatus 600 as illustrated in FIG. 11 stores the small-diameter-particle powder 35 remaining powdery state in a container 42. An un-sintered three-dimensional object 32 is sunk into the small-diameter-particle powder 35 stored in the container 42 to supply the small-diameter-particle powder 35 to the surface of the three-dimensional object 32.

The small-diameter-particle powder supply apparatus 600 of the present embodiment can supply the powdery small-diameter-particle powder 35 even on the surface portion, which is dead angle from outside the three-dimensional object 32. Because the small-diameter-particle powder 35 can operate while running around the three-dimensional object 32, the small-diameter-particle powder 35 can attach to the dead angle portion of the surface of the three-dimensional object 32. Therefore, the small-diameter-particle powder supply apparatus 600 of the present embodiment can supply the small-diameter-particle powder 35 the entire surface of the three-dimensional object 32, even if the surface of the three-dimensional object 32 has a dead angle. Thus, the small-diameter-particle powder supply apparatus 600 can smooth the entire surface of the three-dimensional object 32.

Here, as illustrated in FIG. 10, first, adhesive such as the fabrication liquid 4 is applied to the surface of the three-dimensional object 32. Second, the three-dimensional object 32 is sunk into the small-diameter-particle powder 35 stored in the container 42 in the small-diameter-particle powder supply apparatus 600 of the present embodiment illustrated in FIG. 11. In addition, in this case, by preventing falling of small-diameter-particle powder 35 from the surface of the three-dimensional object 32, a layer thickness of the small-diameter-particle powder 35 deposited on the surface of the three-dimensional object 32 can be made uniform.

Further, a configuration to supply un-sintered small-diameter-particle powder 35 on the surface of the three-dimensional object 32 is not limited to the configurations described above. For example, liquid including the small-diameter-particle powder 35 may be applied to the surface of the three-dimensional object 32. Further, the small-diameter-particle powder 35 can be supplied separately multiple times to the un-sintered surface of the three-dimensional object 32. At this time, a combination of the configurations illustrated in FIG. 9 and FIG. 10 can be used.

Next, a recovery apparatus 50 for recovering the fabrication powder 30 scattered during the forming process of the fabrication layer will be described below.

FIG. 12 is a schematic diagram of the recovery apparatus 50 according to an embodiment of the present disclosure.

Generally, a fabrication powder 30 having a uniform particle diameter as much as possible is used to effectively fabricate a high quality three-dimensional object 32. However, classifying the fabrication powder 30 previously and preparing the fabrication powder having uniform particle size will increase the cost. Therefore, the present embodiment uses a fabrication powder 30 having relatively large variation of particle size distribution. Thus, the fabrication powder 30 in the present embodiment is mixed with a fabrication powder 30, the particle size of which is smaller than the average particle size.

This type of a small-diameter fabrication powder 30 is easier to be raised and scattered by the rotation of the recoat roller 20 during forming the thin layer of fabrication powder 30 over the object layer 31, which is formed by solidifying the fabrication powder 30 with the fabrication liquid 4 discharged from the liquid discharge head 2. Therefore, the present embodiment recovers a scattered fabrication powder 30a having small-diameter, which is raised and scattered by the rotation of the recoat roller 20, by the recovery apparatus 50.

As illustrated in FIG. 12, the recovery apparatus 50 of the present embodiment includes a pump 51, a recovery channel 52, a filter 54, and a recovery container 53. The recovery apparatus 50 suctions the scattered fabrication powder 30a inside the recovery channel 52 by driving the pump 51 and transfer into the recovery container 53 through the recovery channel 52. The present embodiment recovers the scattered fabrication powder 30a by the recovery apparatus 50.

Thus, the variation of particle diameter distribution of the fabrication powder 30 can be reduced, even when the fabrication powder 30 having a relatively large variation of particle diameter distribution is used for fabricating the three-dimensional object 32 in the fabrication chamber 11. Therefore, a high-quality three-dimensional object 32 can be fabricated even when the fabrication powder 30, which is not previously classified, is used.

Further, the scattered fabrication powder 30a transferred to the recovery container 53 can be used as a small-diameter-particle powder 35 for the smoothing process because the particle diameter of the scattered fabrication powder 30a is smaller than the average diameter of the fabrication powder 30 used in the fabrication of the three-dimensional object 32 in the fabrication chamber 11. Thus, the present embodiment has an advantage of effectively utilizing the scattered fabrication powder 30a for the smoothing process without discarding the scattered fabrication powder 30a that is not suitable for fabricating the three-dimensional object 32. The filter 54 such as a classification filter is provided in the recovery channel 52. The filter 54 screens particles having a particle diameter, which can be used as the small-diameter-particle powder 35 in the smoothing process, from the scattered fabrication powder 30a.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. An apparatus for fabricating a three-dimensional object, the apparatus comprising:
a small-diameter-particle powder supplier to supply small-diameter-particle powder to a surface of an object formed by binding fabrication powder with fabrication liquid; wherein:
the small-diameter-particle powder and the fabrication powder are identical in composition, and
an average particle diameter of the small-diameter-particle powder is smaller than an average particle diameter of the fabrication powder.

2. The apparatus as claimed in claim 1, further comprising a small-diameter-particle powder binder to bind the small-diameter-particle powder on the surface of the object.

3. The apparatus as claimed in claim 2, wherein the small-diameter-particle powder binder includes an adhesive applier to apply adhesive, which adheres the small-diameter-particle powder on the surface of the object, before supplying the small-diameter-particle powder on the surface of the object by the small-diameter-particle powder supplier.

4. The apparatus as claimed in claim 3, wherein the adhesive includes a binding agent to bind particles of the fabrication powder.

5. The apparatus as claimed in claim 2, further comprising:
a heater to heat a surface of the object, on which the small-diameter-particle powder is supplied,
wherein the heater sinters the small-diameter-particle powder on the surface of the object and heats the surface of the object to bind the small-diameter-particle powder to the surface of the object.

6. The apparatus as claimed in claim 1, wherein the small-diameter-particle powder supplier includes a sprayer to spray the small-diameter-particle powder on the surface of the object.

7. The apparatus as claimed in claim 1, wherein the small-diameter-particle powder supplier includes a container to store the small-diameter-particle powder, and
the container accommodates the object inside the container to supply the small-diameter-particle powder to the surface of the object.

8. The apparatus as claimed in claim 1, further comprising:
a recovery apparatus to recover the fabrication powder scattered during forming the object,
wherein the small-diameter-particle powder supplier utilizes the fabrication powder, recovered by the recovery apparatus as the small-diameter-particle powder.

9. A method for fabricating a three-dimensional object, the method comprising:
binding particles of a fabrication powder to form an object; and
supplying a small-diameter-particle powder to a surface of the object,
wherein the small-diameter-particle powder and the fabrication powder have an identical composition, and
an average particle diameter of the small-diameter-particle powder is smaller than an average particle diameter of the fabrication powder.

10. The method as claimed in claim 9, further comprising binding the small-diameter-particle powder to the surface of the object.

11. The method as claimed in claim 10, further comprising applying adhesive that adheres the small-diameter-particle powder to the surface of the object before supplying the small-diameter-particle powder on the surface of the object.

12. The method as claimed in claim 11, wherein the adhesive includes a binding agent to bind particles of the fabrication powder.

13. The method as claimed in claim 10, further comprising:
heating the surface of the object, on which the small-diameter-particle powder is supplied, to sinter the small-diameter-particle powder on the surface of the object; and
binding the small-diameter-particle powder to the surface of the object by heating the surface of the object.

14. The method as claimed in claim 9, wherein the supplying of the small-diameter-particle powder includes spraying the small-diameter-particle powder on the surface of the object.

15. The method as claimed in claim 9, wherein the supplying of the small-diameter-particle powder includes:
storing the small-diameter-particle powder; and
accommodating the object inside a container to supply the small-diameter-particle powder to the surface of the object.

16. The method as claimed in claim 9, further comprising:
recovering the fabrication powder scattered during forming the object; and
utilizing the fabrication powder recovered by the recovering as the small-diameter-particle powder.
